(19) United States
(12) Patent Application Publication
(10) Pub. No.: US 2006/0227112 A1
(43) Pub. Date: Oct. 12, 2006

(54) Combined keyboard and wireless transceiver

(75) Inventors: Chih Chang Hsieh, Dove Canyon, CA (US); Suresh Kumar Singamsetty, Carlsbad, CA (US)

Correspondence Address: STEPHEN B. ACKERMAN, 28 DAVIS AVENUE, POUGHKEEPSIE, NY, 12603, US

(73) Assignee: Jaalaa, Inc.

(21) Appl. No.: 11/399,067

(22) Filed: Apr. 6, 2006

Related U.S. Application Data
(60) Provisional application No. 60/669,261, filed on Apr. 7, 2005.

(51) Int. Cl. G09G 5/00

(52) U.S. Cl. 345/168

(57) ABSTRACT

A wireless communication between a mouse and a keyboard connected to a computer with a cable provides a means for connecting mouse signals to a computer. Transceivers located in both the mouse and the keyboard provide RF communications that are converted by the keyboard transceiver to electrical signals to be coupled to the computer through USB or PS/2 ports. An integration of a key scan function with a keyboard transceiver reduces the number of semiconductor chips required in the keyboard.

This application claims benefit of U.S. Provisional Patent Application No. 60/669,261, filed on Apr. 7, 2005, which is herein incorporated by reference in its entirety.

### RELATED PATENT APPLICATION

This application is related to U.S. patent application docket number JA 05-001A, Ser. No. 11/081,376, filed on Mar. 16, 2005; JA 05-001B, Ser. No. 11/081,380, filed on Mar. 16, 2005; JA 05-001D, Ser. No. 11/081,381, filed on Mar. 16, 2005; JA 05-002A, Ser. No. 11/082,009, filed on Mar. 16, 2005; JA 05-002B, Ser. No. 11/082,008, filed on Mar. 16, 2005; and JA 05-002D, Ser. No. 11/081,363, filed on Mar. 16, 2005.

### BACKGROUND OF THE INVENTION

1. Field of Invention

The present invention relates generally to computer systems and, more particularly to an interface between a computer and input devices in communication with the computer over wireless links.

2. Description of Related Art

Computers, microprocessor-based devices and systems have one or more user input devices to allow a user to input information and control certain operations. An input device may be separated from a host computer and a communication link and an interface is implemented to support proper communications between the input device and the host computer. Each of the input devices and the host computer/device includes appropriate software and hardware for the communication link and interface.

As an example, a desk-top or laptop computer may have a keyboard and a pointing device for a user to input data or commands for controlling or operating the computer. Pointing devices for computers include a mouse, a touch pad, a trackball, and a pointing stick (IBM laptops). In addition other user input devices include joysticks and game pads for computers and microprocessor-based game machines and control units for other microprocessor-based devices. A user uses an input button, a control stick, one key or a key combination, or a combination thereof to input data or a command. Circuitry in the input device converts the input data or command into a data form for transmitting to the computer or device.

The input device uses a communication link to communicate the input data or command to the computer or device, where the input device may be a wireless input device using a wireless communication link or a wired link using an electrical cable. Input devices with wired links may be implemented based on PS/2 keyboard interface, USB 1.0 and USB 2.0 and other interfaces. The wireless communication link may be implemented by a radiation transmitter to send the input to a corresponding radiation receiver at the computer or device. Many wireless input devices use RF radiation links based on different radio interfaces such as IEEE 802.5.14 for low speed links and wireless USB 2.0 and IEEE 1394 for relatively high-speed links. Some wired or wireless input devices may use the Human Interface Device (HID) protocol over wired or wireless USB links or other non-USB communication links.

U.S. Pat. No. 6,359,610 (Shah et al.) is directed to a wireless interface system comprising asset of input ports for keyboard, pointing device, joystick signals, data encoding circuit, transmission unit, receiving unit, data decoding circuit, keyboard multiplexer unit, pointing device data multiplexer unit, joystick signal multiplexer unit and a set of output interfaces for connecting to corresponding computer ports. U.S. Pat. No. 6,304,250 (Yang et al.) is directed to a low power consumption keyboard with a pointing device attachable thereto and use with the same, wherein the keyboard communicates with a host computer by a wireless signal. U.S. Pat. No. 5,049,863 (Oka) is directed to a key input unit having both a keyboard and a mouse mechanism wherein the mouse mechanism is detachable from the keyboard and uses an optical signal to communicate to the keyboard when detached. The key input unit connected to a host computer communicates with the keyboard by RF signals when the key input unit is removed from the keyboard. U.S. Pat. No. 4,754,268 (Mori) is directed to a computer system having a keyboard and a mouse in which the mouse communicates with the computing system by means of RF signals.

Wireless input devices increase the flexibility of the interaction between a user and a host computer in that no wired connection is required with the host computer; however, given that a wired connection generally provides a source of power for an input device, wireless input devices are required to be self-powered (e.g., battery-powered). Batteries used to power existing wireless input devices typically last for a period of time significantly less than the useful life of such devices. As a consequence, the convenience and value of such devices are diminished as a consequence of the need for regular battery replacement.

Wireless input devices are frequently of limited range, and the wireless link established for communication with the host computer can be unreliable and/or exhibit a high latency. In addition, such wireless links can be relatively insecure and thus susceptible to eavesdropping or unauthorized monitoring.

### SUMMARY OF THE INVENTION

It is an objective of the present invention to provide a wireless communication link between a pointing device (e.g. a computer mouse) and a computer keyboard.

It is also an objective of the present invention to use a transceiver device in a keyboard to communicate with the function of the keyboard and a transceiver device in the pointing device.

It is also still an objective of the present invention to use a key scan device to communicate to the transceiver device keyboard operations.

It is further an objective of the present invention to integrate the transceiver device and the key scan device into a single device.

In a first embodiment of the present invention a keyboard containing a transceiver is connected to a host computer, and a pointing device, e.g. a computer mouse, is coupled to the keyboard by means of RF transceivers in both the keyboard and the pointing device. The keyboard, having an affinity with the host computer and physically located in close proximity to the host computer, is connected to the host computer by an electrical connection comprising a USB or PS/2 port. The pointing device, although used in close proximity to the host computer, is a moveable device in which wireless RF communications provides a freedom of movement unencumbered by an electrical connection. By connecting the keyboard to the computer with electrical means, an RF transceiver in the computer is eliminated thereby reducing the number of transceivers required as compared to the related patent applications. The pointing device (mouse) used in close proximity to the keyboard allows a reduction in the necessary RF energy transmitted by the keyboard and pointing device transceivers and in turn reduces the power drain on the batteries used to power the pointing device. No batteries are required in the keyboard to power the keyboard transceiver since the keyboard receives power from the computer.

The pointing device, or computer mouse, is coupled to a keyboard transceiver through RF signals, where a keyboard transceiver communicates with a transceiver on the pointing device. Signals representing movement of the pointing device and selection of associated pointing device buttons are converted to RF signals by the pointing device transceiver and coupled to the keyboard transceiver. The keyboard transceiver recognizes the pointing device RF signals and converts the RF signals into electrical signals that are then coupled to the host computer through the USB or PS/2 connections. When the host computer communicates with the pointing device, electrical signals are coupled to the keyboard transceiver through the USB or PS/2 connections. The keyboard transceiver then couples the communication from the Host computer to the pointing device by transmitting a corresponding RF signal. The keyboard transceiver is also used to convey key presses on the keyboard to the host computer through the USB and PS/2 connections. A key scan chip detects the pressing of a keyboard key and sends a signal corresponding to the pressed key to the keyboard transceiver, which couples an electrical signal representing the pressed key to the computer host.

In a second embodiment of the present invention the keyboard transceiver chip and the key scan chip are combined into one chip, and the combined chip communicates directly with the keyboard matrix. A keyboard key press and release is detected by the key scan function on the combined keyboard transceiver and key scan chip. A signal representing the pressed keyboard key is coupled from the key scan function to the transceiver function and then further coupled to the host computer through an electrical connection comprising USB or PS/2 ports.

### BRIEF DESCRIPTION OF THE DRAWINGS

This invention will be described with reference to the accompanying drawings, wherein:

FIG. 1 is a system diagram of the present invention showing the communication connectivity of a host computer, a keyboard and a pointing device;

FIG. 2 is a block diagram of the first embodiment of the present invention, showing the communication between the keyboard transceiver chip, the keyboard scan chip and the pointing device transceiver;

FIG. 3 is a diagram of the keyboard transceiver chip of the first embodiment of the present invention;

FIG. 4 is a block diagram of the second embodiment of the present invention showing the combined keyboard transceiver and key scan chip communicating with the keyboard matrix and the pointing device transceiver; and

FIG. 5 is a diagram of the second embodiment of the present invention combining the keyboard transceiver chip with the keyboard scan chip.

### DETAILED DESCRIPTION OF THE PREFERRED EMBODIMENT

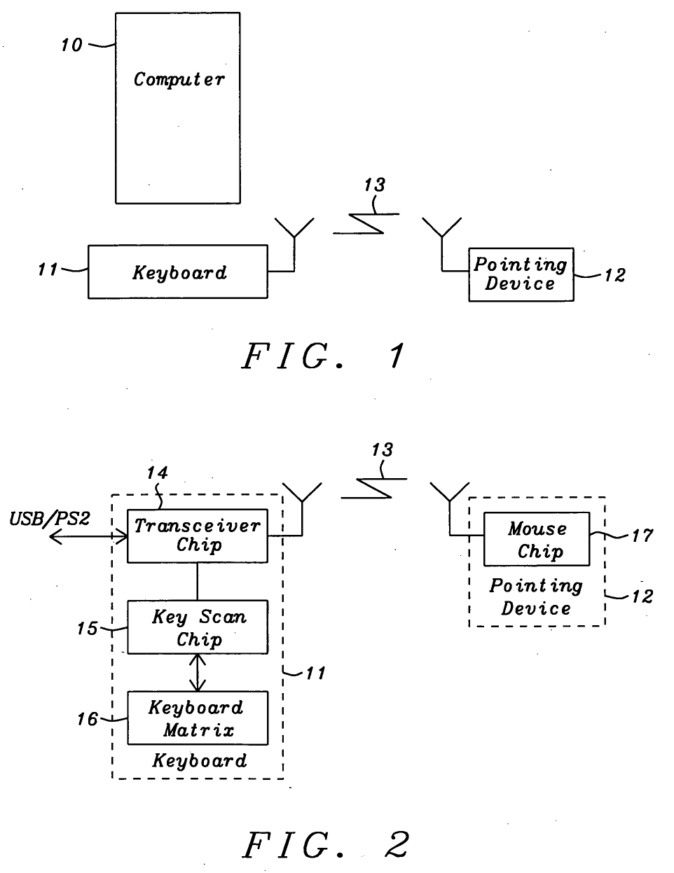

FIG. 1 is a block diagram of the present invention showing the communication between a host computer 10, a keyboard 11 and a pointing device 12, e.g. a mouse. The keyboard 11 has close physical affinity to the computer 10 and generally is used as a stationary device, which is electrically connected to the computer 10 by means of an electrical wire connection to an USB or PS/2 port on the computer. The pointing device 12 (mouse) used generally with frequent movement is coupled to the keyboard 11 using an RF signal 13. The keyboard 11 detects the RF signal 13 from the pointing device, translates the RF signal into an electrical signal, and couples the electrical signal to the host computer 10. The RF communication 13 of the pointing device allows a freedom of movement unencumbered from an electrical connection that is typically used to connect a pointing device such as a mouse to a computer.

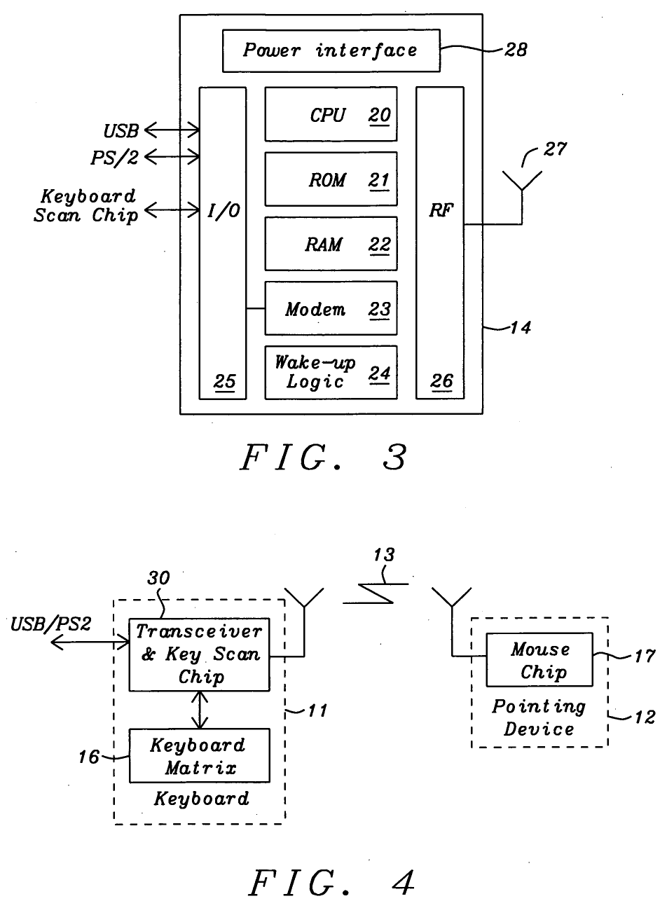

FIG. 2 is a block diagram of the first embodiment of the present invention showing the keyboard 11 and the RF coupling 13 of a keyboard transceiver chip 14 to a mouse chip 17 in the pointing device 12. The keyboard transceiver 14 is coupled to a host computer 10 (FIG. 1) by means of an USB or PS/2 connection. A key scan chip 15 used to detect the press and release of a key on the keyboard matrix 16 couples a signal representing the pressing and releasing of a key to the transceiver chip 14. The transceiver chip 14 sends a signal representing the pressed/released key to the computer 10 by means of the electrical connections. A CPU 20 (FIG.3) processes data from the key scan chip 15, for example to determine key mapping, and a modem 23 (FIG. 3) couples key press and release data to the computer 10 through the USB or PS/2 ports. When the movement of the pointing device, for example a computer mouse, is detected, or an associated key on the pointing device is pressed, the mouse chip 17 detects the movement or key press and couples an RF signal 13 to the transceiver chip 14. The keyboard transceiver chip 14 receives the RF signal 13, and the RF signal is translated into an electrical signal and coupled to the host computer 10.

In FIG. 3 is shown a diagram of first embodiment of the present invention showing the functions included in the keyboard transceiver chip 14. A CPU 20 is coupled by a CPU bus (not shown) to a ROM 21, a RAM 22, a modem 23 and wake-up logic 24. The modem 23 couples electrical signals to and from the data ports comprising USB and PS/2 ports and the keyboard scan chip. The RF unit 26 couples radio frequency signals from the antenna 27 to communicate with the mouse chip 17 in the pointing device 12 (FIG. 2). A power interface 28 provides power regulation to both analog and digital circuitry of the keyboard transceiver chip 14, and the wake-up logic 24 is included in the keyboard transceiver chip for usage in configurations described in the related patent applications.

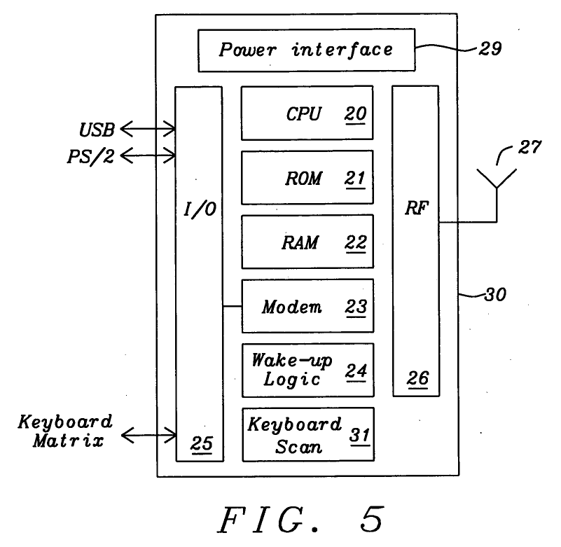

FIG. 4 shows a block diagram of the second embodiment of the present invention. The diagram of FIG. 4 is similar to that of FIG.2 with the exception that the keyboard transceiver chip 30 includes the key scan function shown in FIG. 2 as a separate chip. The keyboard matrix 16 is directly coupled to the transceiver and key scan chip 30 where upon the key scan function detects key presses. The code for detected key press and release is coupled from the key scan function 30 to the transceiver function where a CPU 20 (FIG. 5) processes data from the key scan function, for example to determine key mapping, and the transceiver and key scan chip 30 couples to the host computer 10 (FIG. 1) key presses/releases on the keyboard 11 through the modem 23 (FIG. 5) to the USB or PS/2 ports.

FIG. 5 is a diagram of second embodiment of the present showing the functions included in the keyboard transceiver and key scan chip 30. The diagram of FIG. 5 is substantially the same as that of FIG. 3 with the inclusion of the key scan function 31 being integrated into the transceiver and key scan chip 30. A CPU 20 is coupled by a CPU bus (not shown) to a ROM 21, a RAM 22, a modem 23 and wake-up logic 24. The modem 23 couples electrical signals to and from the data ports comprising USB and PS/2 ports and the keyboard matrix. The RF unit 26 couples radio frequency signals to and from the antenna 27 that are coupled to and from the mouse chip 17 in the pointing device 16 (FIG. 2). A power interface 29 provides power regulation to both analog and digital circuitry of the combined keyboard transceiver and key scan chip 30. The wake-up logic 24 is included in the keyboard transceiver and key scan chip 30 for usage in configurations described in the related patent applications.

The wireless pointing device 12, for instance a computer mouse, operating in close proximity to a keyboard 11 transmits a wireless signal, for instance an RF signal, to the keyboard. The keyboard contains a transceiver chip 14 that receives the wireless signal 13 transmitted by a transceiver located in a mouse chip 12 of the pointing device. The wireless signal contains data describing the movement of the pointing device and the pressing of buttons located on the pointing device. The pointing device is operated in close proximity to the keyboard to minimize the necessary signal strength of the wireless signal and in turn to minimize the power drain on the battery that operates the circuitry of the pointing device. Thus minimizing thenumber of times that the battery needs to be replaced or recharged.

Upon receiving a wireless signal from the pointing device 12, the transceiver 14 within the keyboard converts the data contained in the wireless signals into electrical signals representing the movement of the pointing device and any pressing of buttons on the pointing device. The electrical signals are then coupled to the host computer 10 to which the keyboard is connected by USB or PS2 connections.

While the invention has been particularly shown and described with reference to preferred embodiments thereof, it will be understood by those skilled in the art that various changes in form and details may be made without departing from the spirit and scope of the invention.

What is claimed is:

1. A computing system, comprising:
a) a host computer;
b) a keyboard and a pointing device;
c) said keyboard is coupled to the host computer by a wire connection;
d) said pointing device is coupled to said host computer through wireless communications between RF transceivers located in the keyboard and the pointing device.

2. The system of claim 1, wherein said keyboard further comprises
a) a matrix of keys, a key scan chip and a keyboard transceiver chip;
b) said key scan chip scans said matrix to detect a press and release of a key of said matrix of keys;
c) a processing unit within said keyboard transceiver chip processes key press and release data from the key scan chip; and
d) said keyboard transceiver chip couples the processed key press and release data to the host computer.

3. The system of claim 2, wherein an integration of said key scan into said transceiver chip produces a low cost integrated circuit combination encompassing functions of said key scan and said transceiver.

4. The system of claim 1, wherein said pointing device further comprises:
a) a pointing device transceiver; and
b) said pointing device transceiver couples movement of said pointing device and a pressing of buttons on said pointing device to said keyboard transceiver chip.

5. The system of claim 1, wherein said pointing device operates in close proximity to said keyboard thereby allowing operation at low power to minimize power drain on a battery of said pointing device.

6. The system of claim 3, wherein said pointing device is a computer mouse.

7. A method of coupling a wireless pointing device to a computing system, comprising:
a) using a wireless pointing device in proximity of a keyboard device;
b) coupling wireless signals representing movement and button pressing of said wireless pointing device to said keyboard device;
c) receiving said wireless signals by said keyboard device and translating the wireless signals into electrical signals; and
d) coupling said electrical signals to a computer connected to said keyboard device.

8. The method of claim 7, wherein the pointing device is a computer mouse.

9. The method of claim 7, wherein coupling signals for movement and button pressing of said pointing device is by RF signals from a transceiver in the pointing device to a transceiver in the keyboard device.

10. The method of claim 7, wherein coupling said electrical signals to said computer is by a wire connection between said keyboard device and said computer.

11. The method of claim 7, wherein using said pointing device in proximity of the keyboard device reduces a required strength of said signal resulting in a lower power drain on a battery in said pointing device.

12. A system for communicating between a pointing device and a computer, comprising:
a) a means for a keyboard to receive an RF signal.
b) a means for a pointing device to transmit said RF signal;
c) a means for said keyboard to couple data contained within said RF signal from the pointing device to a computer connected to said keyboard.

13. The system of claim 12, wherein the means for the keyboard to receive said RF signal is an RF transceiver located in the keyboard.

14. The system of claim 12, wherein the means for said pointing device to transmit the RF signal is an RF transceiver in said pointing device.

15. The system of claim 14, wherein the RF signal transmitted by the pointing device contains data that defines movement of the pointing device and a button press of buttons on said pointing device.

16. The system of claim 14, wherein said pointing device is a wireless computer mouse.

17. The system of claim 12, wherein the means for said keyboard to couple data contained within said RF signal to said computer is by translating the data contained in the RF signal into an electrical signal, whereupon said electrical signal is coupled to said computer by a wire connection from said keyboard to said computer.
